(19) United States
(12) Patent Application Publication
(10) Pub. No.: US 2025/0234868 A1
(43) Pub. Date: Jul. 24, 2025

(54) TUNNEL OVEN HEATING ZONE

(71) Applicant: Readling Bakery Systems, Inc., Robesonia, PA (US)

(72) Inventors: Joseph S. ZALESKI, JR., Shoemakersville, PA (US); Richard M. RISSER, Reinholds, PA (US); Tyler S. MARTIN, Wernersville, PA (US)

(21) Appl. No.: 19/027,841

(22) Filed: Jan. 17, 2025

Related U.S. Application Data
(60) Provisional application No. 63/624,359, filed on Jan. 24, 2024.

(51) Int. Cl. A21B 1/22; A21B 1/10; A21B 1/48

(52) U.S. Cl. CPC A21B 1/22; A21B 1/10; A21B 1/48

(57) ABSTRACT

A heating zone for a tunnel oven includes a belt configured to travel axially through the heating zone and support food product thereon. An axially-extending internal baking chamber includes a plurality of first, non-electric panels positioned above the belt and configured to selectively transfer radiant heat into the internal baking chamber. The first panels have a high emissivity surface treatment upon at least a portion thereof. A plurality of electrically heated, high intensity radiant panels are interspersed between the first panels above the belt and are configured to selectively transfer radiant heat to the internal baking chamber. The electrically heated, high intensity radiant panels are configured to output greater radiant heat than the first panels.

### CROSS-REFERENCE TO RELATED APPLICATION

This application claims priority from U.S. Provisional Patent Application No. 63/624,359, filed on Jan. 24, 2024, the entire contents of which are incorporated by reference herein.

### BACKGROUND OF THE DISCLOSURE

This disclosure relates to tunnel ovens, and more particularly to a heating zone for a tunnel oven.

Tunnel ovens are utilized to bake multiple food products. For example, without limitation, tunnel ovens are utilized to bake cookies, crackers, pretzels, and the like. Different food products have different baking profiles. For example, cookies are generally baked in still air to allow the product to rise without crusting or cracking the exterior surface. Cookies also require the conveyor belt to be initially colder so that the cookie does not start baking immediately upon placement on the belt. Crackers, on the other hand, require some air movement and also require a hot belt as product lift results from conductive heat from the belt. Heating the bottom of the product will expand the water content within, causing lift.

It would, therefore, be desirable to design, develop and implement tunnel oven heating zones having different heat transfer vehicles, customizable to employ different baking profiles tailored to the corresponding food product(s).

### BRIEF SUMMARY OF THE DISCLOSURE

Briefly stated, one aspect of the present disclosure is directed to a heating zone for a tunnel oven. The heating zone includes a belt configured to travel axially through the heating zone and support food product thereon. An axially-extending internal baking chamber includes a plurality of first, non-electric panels positioned above the belt and configured to selectively transfer radiant heat into the internal baking chamber. The first panels have a high emissivity surface treatment upon at least a portion thereof. A plurality of electrically heated, high intensity radiant panels are interspersed between the first panels above the belt and are configured to selectively transfer radiant heat to the internal baking chamber. The electrically heated, high intensity radiant panels are configured to output greater radiant heat than the first panels.

### BRIEF DESCRIPTION OF THE SEVERAL VIEWS OF THE DRAWINGS

The following description of embodiments of the disclosure will be better understood when read in conjunction with the appended drawings. It should be understood, however, that the disclosure is not limited to the precise arrangements and instrumentalities shown. In the drawings:

FIG. 1 is a perspective view of a tunnel oven in accordance with an embodiment of the present disclosure;

FIG. 2 is a partial, cross-sectional view of the tunnel oven of FIG. 1, taken along sectional line 2-2;

FIG. 3 is a schematic, front side elevational view of the tunnel oven of FIG. 1;

FIG. 4 is a partial, cross-sectional view of the tunnel oven of FIG. 1, taken along sectional line 4-4;

FIG. 5 is a partial, enlarged view of FIG. 4;

FIG. 6 is a cross-sectional view of the tunnel oven of FIG. 1, taken along sectional line 6-6;

FIG. 7, is a schematic, cross-sectional view of the tunnel oven of FIG. 1, taken along sectional line 6-6;

FIG. 8 is an enlarged, partial perspective, cross-sectional view of the tunnel oven of FIG. 1, taken along sectional line 4-4;

FIG. 9 is a cross-sectional view of an electrified penthouse configuration of the tunnel oven of FIG. 1; and

FIG. 10 is a perspective, cross-sectional view of an alternative configuration of the electrified penthouse of the tunnel oven of FIG. 1.

### DETAILED DESCRIPTION OF THE DISCLOSURE

Certain terminology is used in the following description for convenience only and is not limiting. The terms “lower,” “bottom,” “upper”, “top”, “above” and “below” describe the orientation, or relative orientation, of various elements as they appear in the drawings to which reference is made. The terms “inwardly,” “outwardly,” “upwardly” and “downwardly” refer to directions toward and away from, respectively, the geometric center of the tunnel oven, and designated parts thereof, in accordance with the present disclosure. In describing the tunnel oven, the term proximal is used in relation to the end of the oven closer to the inlet and the term distal is used in relation to the end of the oven closer to the outlet. Unless specifically set forth herein, the terms “a,” “an” and “the” are not limited to one element, but instead should be read as meaning “at least one.” The terminology includes the terms noted above, derivatives thereof and terms of similar import.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other or with the two members coupled to each other using at least one intervening member, unless otherwise indicated. As one example, if the term “coupled” or variations thereof are modified by an additional term (e.g., directly coupled), the aforementioned, generic definition of “coupled” is modified by the plain language meaning of the additional term (e.g., “directly coupled” means the joining of two members without any separate intervening member) Such coupling may be mechanical, electrical, fluidic a combination thereof, or the like, unless otherwise indicated.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X; Y; Z; X and Y; X and Z; Y and Z; or X, Y, and Z (i.e., any combination of X, Y, and Z including just one of them). Thus, such conjunctive language is not generally intended to imply that certain embodiments require at least one of X, at least one of Y, and at least one of Z to each be present, unless otherwise indicated.

The ordinal terms “first,” “second,” etc., as used herein, are used to distinguish one clement from another and do not denote any specific order or sequence, nor do they require the presence of any particular number of elements. It will, therefore, be understood that, unless otherwise indicated, the use of ordinal numbers (e.g., “first,” “second”) in the claims is not intended to limit the scope of the claims to require the presence of both elements associated with those ordinal numbers. For example, the recitation of a “first widget” does not require the presence of a “second widget.”

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude insubstantial or inconsequential modifications or alterations therefrom that are functionally similar, e.g., +/−10%. At a minimum, such references that include a numerical parameter would include variations that, using mathematical and industrial principles accepted in the art (e.g., rounding, measurement or other systematic errors, manufacturing tolerances, etc.), would not vary the least significant digit.

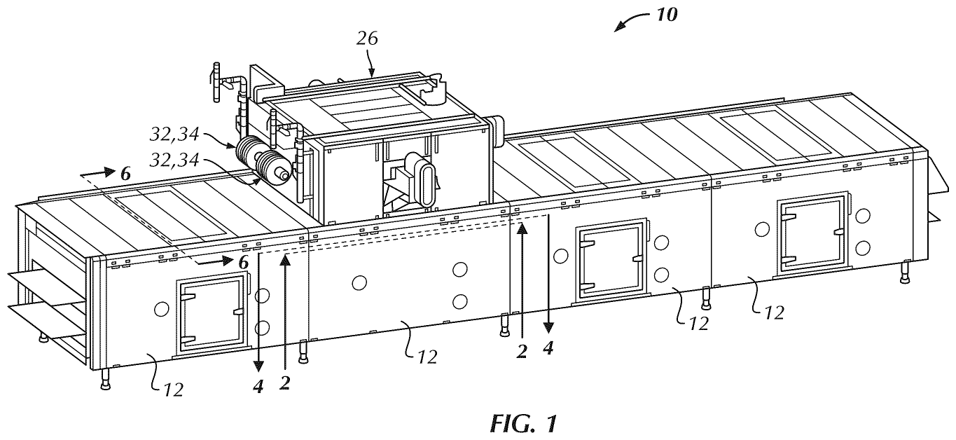

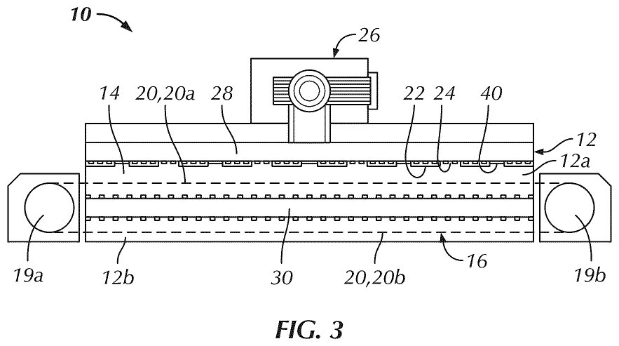

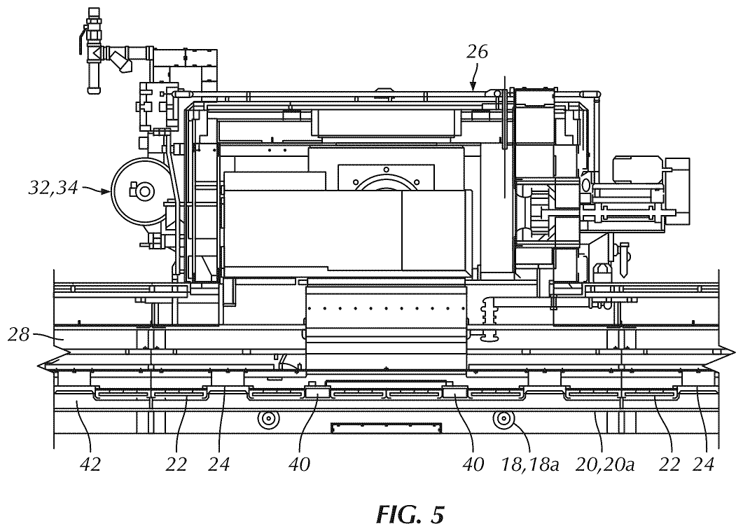

Referring to the drawings in detail, wherein like numerals indicate like elements throughout, there is shown in FIGS. 1-10 a tunnel oven, generally designated 10, in accordance with an embodiment of the present disclosure. The tunnel oven 10 includes at least one axially extending, heating zone 12. In a configuration where a plurality of heating zones 12 are employed, the heating zones 12 are employed axially in series. The successive heating zones 12 may employ the same or different heating zones, e.g., exhibiting the same or different heating techniques, the same or different heating temperatures, the same or different humidity levels, a combination thereof, or the like. The number and dimensions of the heating zones 12 may be selectively configured depending on the food product and the required baking profile. Each heating zone 12 includes an internal baking chamber 14.

In some configurations, as shown in FIGS. 1, 3 and 5-7, the heating zone 12 has multiple levels, e.g., a first or upper level 12a and a second or underlying, lower level 12b. Where a multi-level heating zone 12 is employed, the first level 12a defines the internal baking chamber 14. The tunnel oven 10 further includes a conveyor system 16 including a plurality of rollers 18 laterally extending therein and a belt 20 which travels upon the rollers 18 in the axial direction. In one configuration, ends of the rollers 18 are respectively journaled in the opposing sidewalls of the heating zone 12. In one non-limiting configuration, the rollers 18 may be approximately 24 inches in operative length. In one non-limiting configuration, the belt 20 may be approximately 20 feet in operative length. Where multi-level heating zone(s) 12 are employed, the conveyor system 16 further includes a first, change of direction (terminal) roller, e.g., gear, 19a proximate an inlet of the oven 10 and a second, change of direction (terminal) roller, e.g., gear, 19b proximate an outlet of the oven 10, as well as a plurality of rollers 18a within the first level 12a and a plurality of rollers 18b within the second level 12b. The belt 20a axially travels upon the rollers 18a within the first level 12a, i.e., the baking chamber 14, in a first direction, e.g., forward, and travels around the change of direction roller 19b, which guides the belt 20b into the second level 12b, traveling upon the rollers 18b in an opposing second direction, e.g., reverse. The first, change of direction roller 19b guides the belt 20 exiting the second level 12b back to the first level 12a. Thus, belt 20 return is performed substantially inside the heating zone 12. The belt 20a is configured to carry at least one food product (not shown) thereof, and generally a plurality of food products thereon. In one configuration, the belt 20 may take the form of a closed mesh belt or a solid steel belt, but the disclosure is not so limited. A closed mesh or solid steel belt 20 substantially prevents air penetration therethrough, as will be discussed in further detail below.

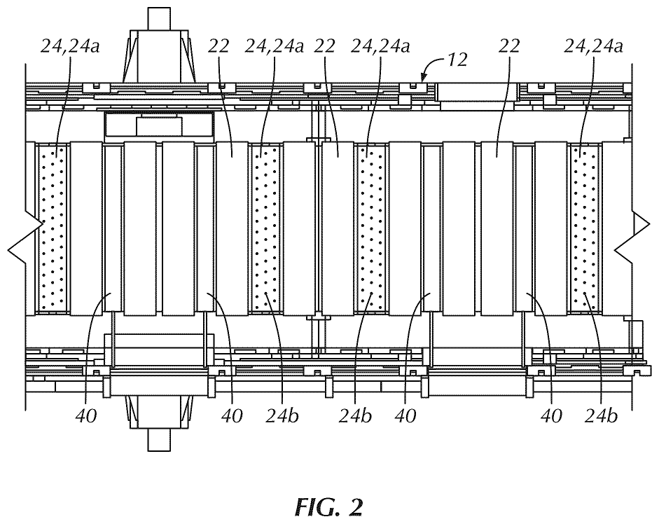

At least one heating zone 12 includes multiple different heat transfer vehicles positioned above the belt 20a and configured to transfer heat into the internal baking chamber 14 in various forms. Advantageously, therefore, and as will be further described, the heating zone(s) 12 operates as a hybrid baking platform capable of producing a variety of baked food products having different baking profiles via different/multiple heat applications. As shown best in FIG. 2, the heating zone 12 includes a plurality of first panels 22 positioned above the belt 20a, having a high emissivity surface treatment/coating upon the surface thereof facing the belt 20a. In one configuration, the first panels 22 are positioned approximately six inches above the belt 20a. In one configuration, the first panels 22 are constructed of a metal material, such as, for example, carbon steel, aluminized steel, stainless steel a combination thereof, or the like. The surface treatment/coating is a chemical treatment/coating which alters the properties of the treated surface to form a surface which has a high emissivity value. The emissivity (8) of a material is the relative ability of the material to emit energy by radiation (i.e., radiant heat distribution). The emissivity values for all materials fall within the range of 0 for reflective materials) to 1 (i.e., for black bodies).

In one embodiment, the chemical conversion coating is black oxide which has a relatively high emissivity, as described in U.S. Pat. No. 10,107,504, the entire contents of which are incorporated by reference herein. Black oxide is a chemical surface treatment which alters the properties to provide the treated surface with a high emissivity value and thus allows for improved radiant heat transfer by the treated surface. More particularly, the surface treatment is a process of forming a black iron oxide at least on the surface of the first panels 22 facing the belt 20a.

Interspersed between the first panels 22 are second panels or sheets 24, each having a perforated surface 24a facing the belt 20a. Each perforated surface 24a defines a plurality of apertures/nozzles 24b facing the belt 20a. In one non-limiting configuration, the ratio of first panels 22 to second panels 24 may be 4:1. In another non-limiting configuration, the ratio of first panels 22 to second panels 24 may be 7:2.

Turning to FIGS. 1 and 3-7, the tunnel oven 10 further includes at least one penthouse 26 positioned upon at least one heating zone 12. In the illustrated embodiment, the tunnel oven 10 includes a single central penthouse 26, but the disclosure is not so limited and multiple penthouses 26 may be employed. As should be understood by those of ordinary skill in the art, the penthouse 26 is configured to heat air to a predetermined temperature and transfer the heated air to an upper (first) plenum 28. Air within the upper plenum 28 is ultimately, selectively transferred to the first and/or second panels 22, 24, as will be described in further detail below. Where a multi-level heating zone 12 is employed, the penthouse 26 also transfers heated air to a lower (second) plenum 30, as will be described in further detail below.

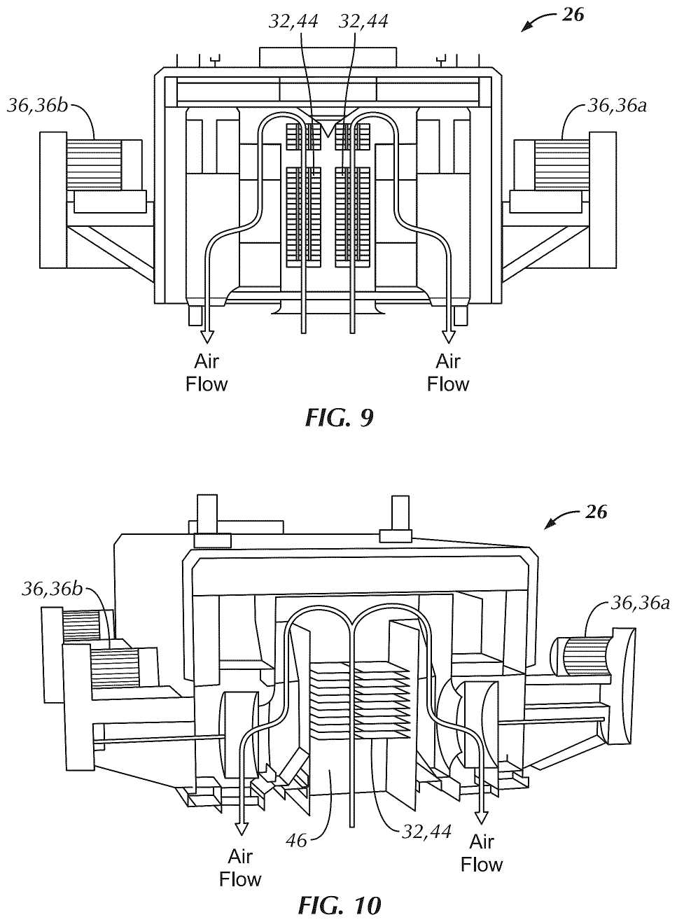

The penthouse 26 includes at least one heating element 32. As should be understood by those of ordinary skill in the art, air temperature is controlled via heating element 32 control. In the illustrated embodiment of FIGS. 1-8, the heating element 32 takes the form of a gas burner 34. In the illustrated embodiment, the penthouse 26 includes two gas burners 34 (i.e., an upper plenum heating element and a lower plenum heating element): one for each plenum 28, 30, but the disclosure is not so limited. As should be understood, the penthouse 26 may include a single heating element 32 (including for multi-level heating zones 12) or more than two heating elements 32. Alternatively, the heating element 32 may take the form of an electric heating element, such as, for example, without limitation, an electric coil heater 44 (see FIGS. 9, 10). As shown in FIG. 9, the penthouse 26 may employ a pair of electric coil heaters 44, one designated for each plenum 28, 30. Alternatively, as shown in FIG. 10, the penthouse 26 may employ a single electric coil heater 44, positioned within a central heat box 46, sufficient for both plenums 28, 30. In one non-limiting example, the electric coil heater(s) may be between approximately a 150 kW heater and approximately a 260 kW heater. As should be understood by those of ordinary skill in the art, air is drawn/forced through the electric coils for heating. Advantageously, electric heating elements are simpler to maintain and operate due to less parts.

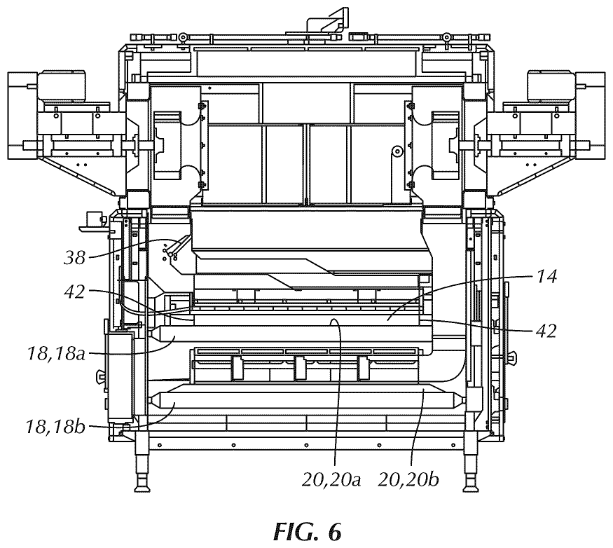

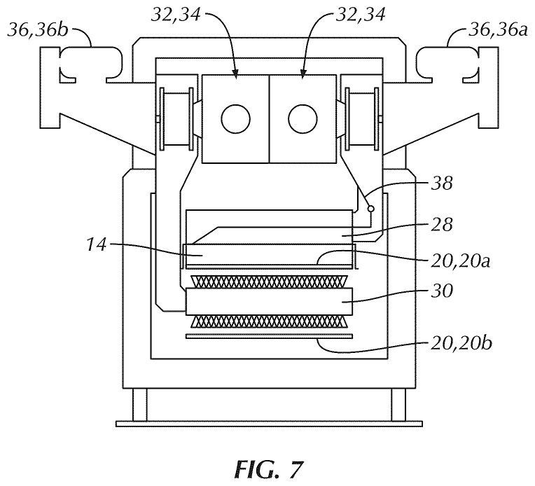

As shown in FIGS. 6 and 7, the penthouse 26 further includes at least one circulation blower 36. In the illustrated embodiment, the penthouse 26 includes an upper plenum, circulation blower 36a (first circulation blower) and a lower plenum, circulation blower 36b (second circulation blower). The upper plenum, circulation blower 36a is in fluid communication with the upper plenum 28, e.g., via ductwork The lower plenum, circulation blower 36b is in fluid communication with the lower plenum 30, e.g., via ductwork. As should be understood by those of ordinary skill in the art, the circulation blowers 36a, 36b suction heated air, heated by the burners 34 within the penthouse 26, and force the heated air from the penthouse 26 to the requisite plenums 28, 30 via the connecting ductwork.

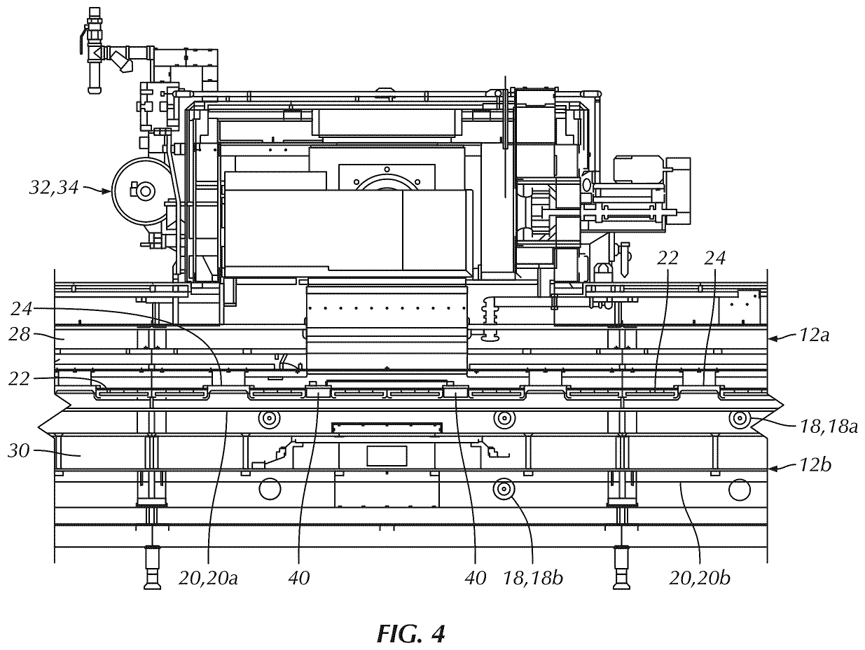

As shown best in FIGS. 4-7, the upper plenum 28 is positioned proximate, e.g., above, the first panels 22. Therefore, the heated air in the upper plenum 28 impinges upon the panels 22, which, in turn, radiate (resulting from the high emissivity treatment/coating) into the baking chamber 14 in a manner well understood by those of ordinary skill in the art. The air within the upper plenum 28 is ultimately recycled back to the penthouse 26 and does not impinge upon the food product. In one configuration, the panels 22 have a face temperature between the range of approximately 150° F. and approximately 650° F. Operation of the first panels 22 creates a substantially still air, radiant baking chamber 14. Food products such as cookies should be baked in a still air environment, in order allow the cookies to grow and expand without crusting the exterior surface which would create undesirable cracking of the surface.

As shown in FIG. 6, a selectively actuatable flow damper 38 is employed in the ductwork between the upper plenum, circulation blower 36a and the panels 22, 24. In the closed position, as shown in FIG. 6, the flow damper 38 substantially blocks the heated air from flowing to the second panels 24 and entering into the baking chamber 14 via the apertures/nozzles 24b. When selectively actuated into an open position, e.g., mechanically, electrically, a combination thereof, or the like, a flow path to the second panels 24 is opened, thereby enabling heated air to travel into the baking chamber 14 via the apertures/nozzles 24b. Accordingly, the second panels 24 contribute to a source of convective heating of the oven chamber 14, wherein the heated air impinges onto the food product on the belt 20a. Convective heating is generally beneficial for moisture removal from, i.e., drying, the food product.

As shown best in FIGS. 2-5, the heating zone 12 further includes another heat transfer vehicle positioned above the belt 20a for transferring heat to the internal baking chamber 14. The heating zone 12 includes a plurality of third panels 40 positioned above the belt 20a and also interspersed between the first panels 22. The third panels 40 take the form of electrically heated, high intensity radiant panels. Each third panel 40 is individually electrically heated, e.g., without limitation, via one or more internal electrically resistive grids. The third panels 40 output greater radiant heat than the first panels 22. In one configuration, the third panels 40 have a face temperature between the range of approximately 700° F. and approximately 1300° F. The third panels 40 are selectively powered on or off, with separate control from the first and second panels 22, 24. Advantageously, the third panels 40 may be operated for food products that require more energy to bake. In one configuration, two of the third panels 40 may be employed per three-meter section. In one configuration, the third panels 40 may each be approximately 150 mm wide, i.e., their dimension along the axial axis of the tunnel oven 10. In one non-limiting configuration, the ratio of first panels 22 to second panels 24 to third panels 40 may be 7:2:1.

As shown best in FIG. 6, within the first level 12a of the heating zone 12, two solid, e.g., stainless steel, side skirts/side curtains 42 and the extend downward from opposing ends (or proximate the opposing ends) of the panels 22, 24, 40 to the belt 20a. The enclosure created by the panels 22, 24, 40, the side curtains 42 and the closed mesh or solid steel belt 20a helps to build humidity within the baking chamber 14 from the moisture exiting the food product. Particularly when operating as a convection oven, humidity levels are low due to the circulation of air and the enclosure created by the panels 22, 24, 40, the side curtains 42 and the closed mesh or solid steel belt 20a advantageously raises and/or maintains the humidity level.

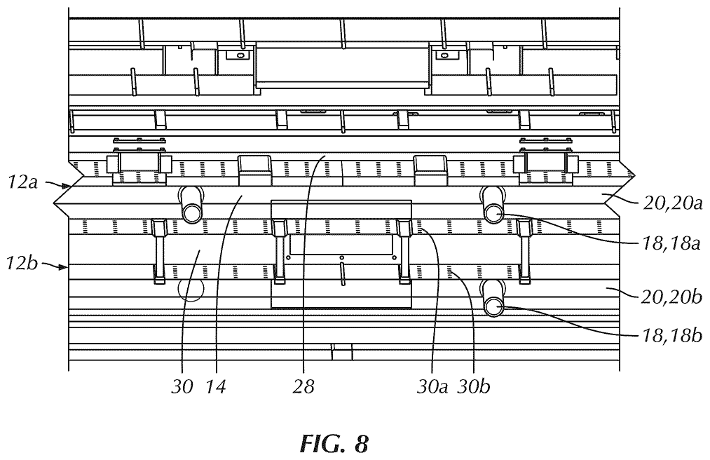

Turning to the second level 12b of the heating zone 12, as shown best in FIG. 8, the lower plenum 30 underlies the belt 20a within the first level 12a and overlies the belt 20b within the second level 12b. The lower plenum 30 is perforated with nozzles (or apertures) 30a along an upper surface thereof and perforated with nozzles (or apertures) 30b along a lower surface thereof. The lower plenum, circulation blower 36b forces heated air to the lower plenum 30, which exits through the nozzles 30a, 30b. As previously described, the penthouse 26 of the present configuration includes two burners 34, one designated for each plenum 28, 30. Accordingly, when selectively activated, the lower plenum, circulation blower 36b may force heated air produced by the corresponding burner 34 to the lower plenum 30. In an alternative configuration wherein the penthouse 26 includes a single burner 34, however, the single burner 34 may produce heated air for both plenums 28, 30.

The heated air exiting the nozzles 30a heats the belt 20a traveling within the baking chamber 14 in the first level 12a. Advantageously, heating of the belt 20a is a source of conductive heat to food products. Therefore, the tunnel oven 10 is suitable for baking food products that require conductive heat via the belt 20a, such as crackers. The conductive heat of the belt 20a provides lift of the food product as the belt 20a heats the bottom of the food product, thereby expanding the water in the product to provide lift. The heated air exiting the nozzles 30b heats the belt 20b traveling within the second level 12b during the return path of the belt 20b. Accordingly, and advantageously, the lower plenum 30 also preheats the belt 20, which otherwise accounts for approximately 25% of the heat loss during the baking process because of the otherwise constant reheating required after exiting the oven.

It will be appreciated by those skilled in the art that changes could be made to the embodiment(s) described above without departing from the broad inventive concept thereof. It is understood, therefore, that this disclosure is not limited to the particular embodiments disclosed, but it is intended to cover modifications within the spirit and scope of the present disclosure as defined by the present description, as set forth in the appended claims.

I/We claim:

1. A heating zone for a tunnel oven, the heating zone comprising:
a belt configured to travel axially through the heating zone supporting food product thereon; and
an axially-extending internal baking chamber having:
a plurality of first, non-electric panels positioned above the belt and configured to selectively transfer radiant heat into the internal baking chamber, the first panels having a high emissivity surface treatment upon at least a portion thereof; and
a plurality of electrically heated, high intensity radiant panels interspersed between the first panels above the belt and configured to selectively transfer radiant heat to the internal baking chamber, the electrically heated, high intensity radiant panels configured to output greater radiant heat than the first panels.

2. The heating zone of claim 1, wherein each high intensity radiant panel is individually electrically heated, and wherein the high intensity radiant panels are selectively operated, separately from the first panels.

3. The heating zone of claim 1, further comprising a first, axially extending, solid side curtain and a second, axially extending, solid side curtain, the first and second side curtains extending downwardly toward the belt.

4. The heating zone of claim 3, wherein the first and second side curtains are constructed of steel.

5. The heating zone of claim 1, wherein the belt is configured to substantially prevent air penetration therethrough.

6. The heating zone of claim 5, wherein the belt is a closed mesh belt or a solid steel belt.

7. The heating zone of claim 1, wherein the internal baking chamber further comprises a plurality of second panels interspersed between the first panels above the belt and configured to selectively transfer heat into the internal baking chamber, each second panel having a perforated surface facing the belt, defining a plurality of openings configured to permit convective heat transfer into the internal baking chamber therethrough.

8. The heating zone of claim 7, wherein a ratio of first panels to second panels is 4:1.

9. A tunnel oven comprising:
the heating zone of claim 1;
a first plenum positioned proximate the first panels; and
a penthouse configured to heat air for the internal baking chamber, the penthouse comprising:
a heating element; and
a circulation blower in fluid communication with the first plenum, the circulation blower being configured to transfer heated air from the heating element to the first plenum, whereby heated air in the first plenum impinges upon the first panels, to, in turn, radiate into the internal baking chamber.

10. The tunnel oven of claim 9, wherein the internal baking chamber further comprises a plurality of second panels interspersed between the first panels above the belt and configured to selectively transfer heat into the internal baking chamber, each second panel having a perforated surface facing the belt, defining a plurality of openings configured to permit convective heat transfer into the internal baking chamber therethrough, and
the tunnel oven further comprising a flow damper, the flow damper being selectively actuatable between a closed position, substantially fluidly disconnecting the circulation blower from the second panels, and an open position fluidly connecting the circulation blower with the second panels, thereby enabling the heated air to travel to the second panels and into the internal baking chamber via the plurality of openings of the second panels.

11. The tunnel oven of claim 9, wherein the heating element comprises a gas burner.

12. The tunnel oven of claim 9, wherein the heating element comprises an electric heating element.

13. A tunnel oven comprising:
the heating zone of claim 1, wherein the heating zone includes a first level and an underlying second level, the first level defining the internal baking chamber, and wherein the belt is a continuous belt; and
a conveyor system having a first, change of direction roller, an opposing, second, change of direction roller, a plurality of rollers positioned therebetween and the belt, the plurality of rollers including a plurality of rollers positioned within the first level and a plurality of rollers positioned within a second level, whereby a portion of the belt travels axially along the rollers within the first level in a first direction and a portion of the belt travels axially along the rollers within the second level in an opposite, second direction, the belt changing directions along the first and second change of direction rollers.

14. The tunnel oven of claim 13,
a first plenum positioned within the first level, proximate the first panels;
a second plenum positioned within the first level, underlying the portion of the belt traveling within the first level and overlying the portion of the belt traveling within the second level; and
a penthouse configured to heat air, the penthouse comprising:
at least one heating element; and
a first circulation blower in fluid communication with the first plenum, the circulation blower being configured to transfer heated air from the at least one heating element to the first plenum, whereby heated air in the first plenum impinges upon the first panels, to, in turn, radiate into the internal baking chamber; and
a second circulation blower in fluid communication with the second plenum, the circulation blower being configured to transfer heated air from the at least one heating element to the second plenum.

15. The tunnel oven of claim 14, wherein the second plenum is perforated with openings along an upper surface thereof, whereby the heated air in the second plenum exits through the openings along the upper surface and heats the portion of the belt traveling within the first level.

16. The tunnel oven of claim 15, wherein the second plenum is also perforated with openings along a lower surface thereof, whereby the heated air in the second plenum also exits through the openings along the lower surface and heats the portion of the belt traveling within the second level.

17. The tunnel oven of claim 14, wherein the at least one heating element comprises two selectively activatable heating elements, a first of the two heating elements being in fluid communication with the first circulation blower and a second of the two heating elements in fluid communication with the second circulation blower.

18. The tunnel oven of claim 14, wherein the at least one heating element comprises at least one gas burner.

19. The tunnel oven of claim 14, wherein the at least one heating element comprises at least one electric heating element.

20. The tunnel oven of claim 14, wherein the internal baking chamber further comprises a plurality of second panels interspersed between the first panels above the belt and configured to selectively transfer heat into the internal baking chamber, each second panel having a perforated surface facing the belt, defining a plurality of openings configured to permit convective heat transfer into the internal baking chamber therethrough, and
wherein the tunnel oven further comprising a flow damper, the flow damper being selectively actuatable between a closed position, substantially fluidly disconnecting the first circulation blower from the second panels, and an open position fluidly connecting the first circulation blower with the second panels, thereby enabling the heated air to travel to the second panels and into the internal baking chamber via the plurality of openings of the second panels.
